(19) United States
(12) Patent Application Publication
(10) Pub. No.: US 2021/0264523 A1
(43) Pub. Date: Aug. 26, 2021

(54) System and Method for Presenting Insurance Data in an Interactive Pictorial User-Interface

(71) Applicant: STATE FARM MUTUAL AUTOMOBILE INSURANCE COMPANY, Bloomington, IL (US)

(72) Inventors: David Kuriyan Schuster, Bloomington, IL (US); Ivan Dustan Hall, Bloomington, IL (US)

(21) Appl. No.: 14/723,030

(22) Filed: May 27, 2015

Related U.S. Application Data
(60) Provisional application No. 62/105,601, filed on Jan. 20, 2015.

(51) Int. Cl. G06Q 40/08; G06F 3/0484

(52) U.S. Cl. CPC G06Q 40/08; G06F 3/04842

(57) ABSTRACT

A method, system and computer-readable medium facilities presenting insurance data within an interactive pictorial user-interface. An insurance customer provides a log-in to the system and objects comprising insurance data corresponding to the customer are retrieved. The objects may represent insureds, family members, insurance policies (e.g., auto, home, life), insurance claims, and/or other items, and may be icons or photos, for example. A determination may be made of a pictorial, graphical, and/or virtual representation of each of the one or more objects. Another determination may be made regarding the relationships between the one or more objects. A size and/or arrangement of the pictorial representation of the objects may be determined based upon the determined relationships. The objects are then displayed via a client device as an interactive pictorial user-interface. The user-interface may include various views, such as customer-centric, insurance policy-centric, insurance claim-centric, and/or loss report-centric views, displays, graphical depictions, or summaries.

### CROSS-REFERENCE TO RELATED APPLICATIONS

This application claims the benefit of U.S. Provisional Application No. 62/105,601, filed Jan. 20, 2015, which is incorporated by reference herein in its entirety.

### FIELD OF THE DISCLOSURE

The following disclosure relates to a system and method for providing a visually engaging representation of insurance information in an interactive pictorial user-interface.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A customer of an insurance provider may require information regarding current policies and other historical insurance data. Currently, insurance providers may present this type of data as text via a webpage or by physical printouts. The text may be formatted into data tables or divided by sections, but unfortunately the user experience for retrieving data is still cumbersome and unintuitive.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present embodiments may be related to a system for displaying insurance data in a visually engaging format that utilizes easily recognizable pictorial depictions of insurance data objects in an interactive user-interface. The system may be enabled to retrieve data from various data sources, including local memory of a client device and/or various databases. The system may implement a module to make a series of determinations regarding how to present the insurance data. The present embodiments may present the insurance data via a display of a client device. The system may alter the presentation of the insurance data based upon input received via the client device.

One aspect of the technique of the disclosure is a computer-implemented method for displaying insurance data in an interactive pictorial user-interface. The method may include (1) receiving, via a computer network, a log-in corresponding to a customer of an insurance provider; and/or (2) retrieving, by one or more processors, one or more objects comprising insurance data corresponding to the customer of the insurance provider. The method may include (3) determining, by the one or more processors, a pictorial representation for each of the one or more objects; (4) determining, by the one or more processors, relationships between the one or more objects; and/or (5) determining, by the one or more processors, a size and/or an arrangement of the pictorial representation of the one or more objects to be displayed based upon the determined relationships. The method may also include (6) displaying, via a display of a client device, the objects in an interactive user-interface based upon the determined size and/or arrangement of the pictorial representation of the one or more objects. The pictorial representation of the one or more objects may include a plurality of nodes in a web-diagram, and/or a plurality of branches of the web-diagram may correspond to the determined relationships of the objects. The method may include additional, fewer, or alternate actions, including those discussed elsewhere herein.

In another aspect, a computer device may be implemented to display insurance data in an interactive pictorial user-interface. The computer device may comprise one or more processors and one or more memories coupled to the one or more processors. The one or more memories may include computer executable instructions stored therein that, when executed by the one or more processors, cause the one or more processors to perform a plurality of functions. For example, the instructions may cause the one or more processors to receive a log-in corresponding to a customer of an insurance provider. The instructions may further cause the one or more processors to retrieve one or more objects comprising insurance data corresponding to the customer of the insurance provider. The instructions may further cause the one or more processors to determine a pictorial representation for each of the one or more objects; determine relationships between the one or more objects; and/or determine a size and/or an arrangement of the pictorial representation of the one or more objects to be displayed based upon the determined relationships. The instructions may further cause the one or more processors to display the objects in an interactive user-interface based upon the determined size and/or arrangement of the pictorial representation of the one or more objects. The pictorial representation of the one or more objects may include a plurality of nodes in a web-diagram, and/or a plurality of branches of the web-diagram may correspond to the determined relationships of the objects. The computer device may include additional, less, or alternate functionality, including that discussed elsewhere herein.

In still another aspect, a tangible computer-readable medium may include non-transitory computer readable instructions stored thereon to display insurance data in an interactive pictorial user-interface. For example, the instructions may include receiving, a log-in corresponding to a customer of an insurance provider; and/or retrieving one or more objects comprising insurance data corresponding to the customer of the insurance provider. The instructions may include determining a pictorial representation for each of the one or more objects; determining relationships between the one or more objects; and/or determining a size and/or an arrangement of the pictorial representation of the one or more objects to be displayed based upon the determined relationships. The instructions may also include displaying the objects in an interactive user-interface based upon the determined size and/or arrangement of the pictorial representation of the one or more objects. The pictorial representation of the one or more objects may include a plurality of nodes in a web-diagram, and/or a plurality of branches of the web-diagram may correspond to the determined relationships of the objects.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 is a simplified and exemplary block diagram of a system for presenting insurance data in an interactive pictorial user-interface;

FIG. 2 is a flowchart illustrating an exemplary method for presenting insurance data in an interactive pictorial user-interface;

FIG. 3 is an illustration of an exemplary user interface displaying a customer view of an interactive pictorial user-interface;

FIG. 4 is an illustration of an exemplary user interface displaying a policy view of an interactive pictorial user-interface;

FIG. 5 is an illustration of an exemplary user interface displaying a claim view of an interactive pictorial user-interface;

FIG. 6 is an illustration of an exemplary user interface displaying a loss report view of an interactive pictorial user-interface; and

FIG. 7 depicts an exemplary computing environment for implementing the systems and methods discussed herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Insurance customers may have many different types of policies covering various people and/or items. It may be difficult for an insurance customer to keep track of all the information relating to their insurance coverage, and current methods for presenting insurance information only utilize formatted text which may be an inefficient manner for presenting such information. The current application relates to employing a visually engaging, virtual or graphical representation of complex information within an interactive pictorial user-interface.

The data represented by the interactive user-interface may include data entities relating to insurance coverage such as people, vehicles, policies, claims, etc. The data may be represented in the interface as objects with pictures that make the objects immediately recognizable. The data may be presented in a web diagram that represents the manner in which different objects are related. Any object in the user-interface may be clicked to give that particular object focus. When an object gains focus, details (such as normally hidden or readily not apparent details) about that object may be displayed, as well as the relationships (such as normally hidden or readily not apparent relationships) between the selected object and/or other objects. Further, when an object is selected, the web diagram may be refocused with the selected object becoming the central object in the web-diagram.

The interactive pictorial user-interface of the current application may be configured in a variety of ways. The interactive user-interface (UI) may be applied to display an overview of a customer and/or his relationships to policies, claims, other people, agents, etc. The interactive UI may also be implemented to display an overview of an insurance policy, and may include components such as policy role players, insured property, different types of coverage, etc. The interactive UI may be further implemented to display an overview of an insurance claim, including involved vehicles, participants, insurance policies, claim handlers, etc. The interactive UI may also be implemented to collect data, for example, in the context of a loss report.

The interactive pictorial user-interface may present insurance-related information in a much more interesting and intuitive depiction of complex data relationships. Objects and relationships between objects may be immediately visible and/or understandable to insurance customers. Being pictorial or graphical in nature, the user-interface may transcend language barriers. The user-interface may also provide a more dynamic and interactive customer experience to captivate insurance customers and/or insurance provider representatives.

The user-interface may provide virtual or graphical representations (such as via icons or avatars) associated with (1) various types of insurance policies, such as auto, home, life, health, renters, pet, burial, and/or other types of insurance; (2) insurance claims; (3) customers, insureds, and/or family members of customers; (4) loss reports; and/or other types of information. The user-interface may provide a number of different views, such as customer-centric, insurance policy-centric, insurance claim-centric, and/or loss report-centric views, pages, or displays. For instance, the virtual representative of a customer, insurance policy, or insurance claim may be centrally located (or approximately located) within a page, webpage, or display associated with the user-interface. Additionally or alternatively, the virtual or graphical representations may be associated with individual insurance premiums, rates, discounts, rewards, and/or points.

### I. Exemplary System

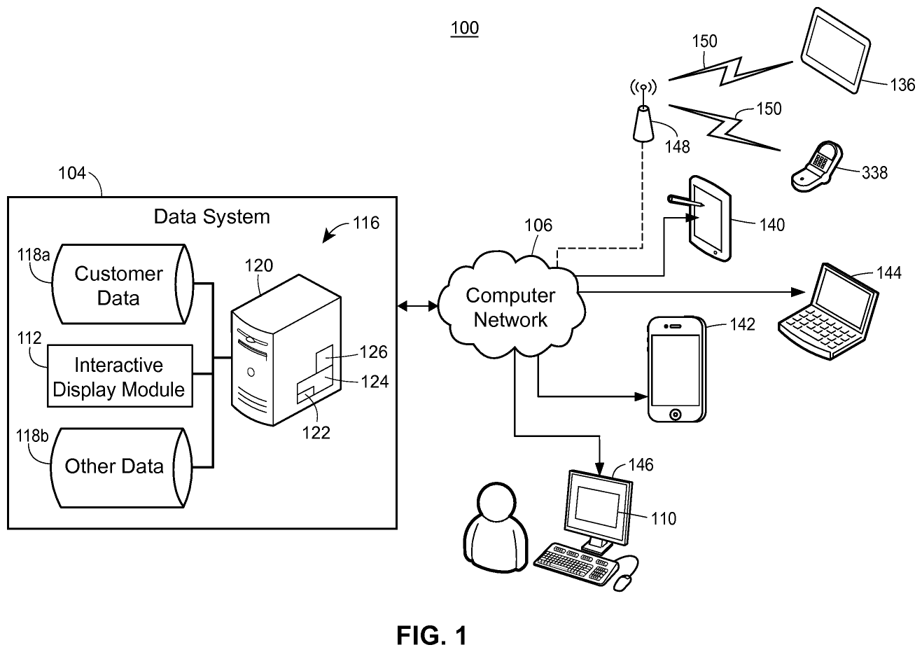

FIG. 1 generally illustrates one embodiment for a system 100 to present insurance data in an interactive pictorial user-interface (UI). The system 100 may include hardware and software applications, as well as various data communication channels for facilitating data communications between the various hardware and software components. The system 100 may include clients 136, 138, 140, 142, 144 and/or 146 as front-end components and back-end components 104 in communication with each other via a communication link 106 (e.g., computer network, internet connection, etc.).

FIG. 1 illustrates a block diagram of a high-level architecture of an interactive UI system 100 including various software and/or computer-executable instructions and/or hardware components and/or modules that may employ the software and/or instructions to present insurance data in an interactive pictorial user-interface. The various modules may be implemented as computer-readable storage memories containing computer-readable instructions (i.e., software) for execution by a processor of the computer system 100. The modules may perform the various tasks associated with presenting insurance data in an interactive pictorial user-interface, as herein described. The computer system 100 may also include both hardware and software applications, as well as various data communications channels for communicating data between the various hardware and software components.

The client devices 136-146 may include, by way of example, a mobile device (such as a tablet computer 136, a cell phone 138, a personal digital assistant (PDA) 140, a smart-phone 142, a laptop computer 144, a portable media player (not shown), a wearable computing device (not shown), smart watches, smart bracelets, phablets, etc.), a desktop computer 146, other smart devices, devices configured for wired and/or wireless RF (Radio Frequency) communication, etc. Of course, any client or mobile device appropriately configured may interact with the interactive UI system 100.

The client devices 136-146 need not necessarily communicate with the network 106 via a wired connection. In some instances, the client devices 136-146 may communicate with the network 106 via wireless signals 150 and, in some instances, may communicate with the network 106 via an intervening wireless and/or wired device 148, which may be a wireless router, a wireless repeater, a base transceiver station of a mobile telephone provider, etc.

Each of the client devices 136-146 may interact with the data system 116 to receive web pages and/or server data from the server 120 and may display the web pages and/or server data via a client application and/or an internet browser (described below). For example, the mobile device 142 may display insurance data in an interactive user-interface on a client application and/or through a web page to a user, may receive an input from the user, and may interact with the data system 116. It will be appreciated that although only one server 120 is depicted in FIG. 1, multiple servers 120 may be provided for the purpose of distributing server load, serving different web pages, etc. These multiple servers 120 may include a web server, an entity-specific server (e.g. an Apple® server, etc.), a server that is disposed in a retail and/or proprietary network, etc.

The interactive display module 112 may retrieve data from the various databases 118a and/or 118b. The databases 118a and/or 118b may be maintained by, for example, an insurance provider. Generally, the customer data 118a and/or other data 118b may store information relating to insurance policies, such as customer information (name, address, social security number, etc.), past and/or present insurance policies, incident reports, etc. The module 112 may also be implemented to receive data through client devices 136-146 to be stored in customer data 118a and/or other data 118b.

The client may contain a GUI 110, which may communicate with the system 116 through the network 106 or other type of suitable network (local area network (LAN), a metropolitan area network (MAN), a wide area network (WAN), a mobile, a wired and/or wireless network, a private network, a virtual private network, etc.). The digital network 106 may be a proprietary network, a secure public Internet, a virtual private network and/or some other type of network, such as dedicated access lines, plain ordinary telephone lines, satellite links, combinations of these, etc. Where the digital network 106 comprises the Internet, data communication may take place over the digital network 106 via an Internet communication protocol.

A system server 120 may send and/or receive information and/or data 118a and/or 118b for the system 100, such as computer-executable instructions and/or data associated with applications executing on the clients 136-146 (e.g., the interactive display module 112). The applications executing within the system 100 may include cloud-based applications, web-based interfaces to the data system 116, software applications executing on the clients, and/or applications including instructions that are executed and/or stored within any component of the system 100. The applications, GUI 110, browser, and module 112 may be stored in various locations including separate repositories and/or physical locations.

In some embodiments, the data system 116 in general and/or the server 120 in particular may include computer-executable instructions 122 stored within a memory 124 of the server 120 and/or executed using a processor 126. The instructions 122 may instantiate an interactive display module 112 and/or send instructions to the clients 136-146 to instantiate a GUI 110 for the tool 112 using a web browser application of a client. In some embodiments, the browser application, GUI 110, interactive display module 112, and/or elements of the data system 116 may be implemented at least partially on the server 120 and/or clients 136-146. The data system 116 and/or processor 126 may execute instructions 122 to display the GUI 110 including the data 118a and/or 118b within a display of the clients 136-146 and/or server 120 (not shown). For simplicity, only one GUI 110 is provided in the exemplary system 100, although this is not intended to limit the number and/or location of the GUI 110.

In one aspect, the module 112 may be a client application that may be implemented as a series of machine-readable instructions for performing the various tasks associated with implementing the interactive user-interface system 100, as well as receiving information, displaying information, and/or transmitting information between devices 136-146 and/or server 120.

In various aspects, the module 112 may be implemented as a stand-alone system and/or as a system wherein the front-end components 136-146 communicate with back-end components 104 as described herein. Additionally, the module 112 may include machine-readable instruction for implementing a user interface to allow a user to input commands to receive information from the interactive user-interface system 100 in accordance with the functionality supported by the module 112.

The module 112 may be a native web browser, such as Apple's Safari®, Google Android™ mobile web browser, Microsoft Internet Explorer® for Mobile, Opera Mobile™, that may be implemented as a series of machine-readable instructions for receiving, interpreting, and/or displaying web page information from the server 120 and/or other back-end components 104 while also receiving inputs from the user. The module 112 may include an embedded web browser that may be implemented as a series of machine-readable instructions for receiving, interpreting, and/or displaying web page information from the servers 120 and/or other back-end components 104 within client devices 136-146.

In one aspect, the module 112 may be an application that is installed on devices 136-146. For example, the interactive display module 112 may be downloaded and/or installed to device 142 by a user. Additionally or alternatively, the module 112 may include instructions for implementing a user interface to allow a user to input commands and/or respond to prompts. For example, the module 112 may allow a user to select clickable icons (such as through a touch screen interface) and/or enter information through text inputs.

The module 112 serves to advantageously allow for quick and accurate creation of an interactive pictorial user-interface to display insurance information. For instance, the module 112 is designed such that it enables efficient data retrieval, from databases 118a and/or 118b. Further, the module 112 is configured to process and present insurance in the interactive pictorial user-interface. Thus, the module 112 provides significant improvement to the system by effectively retrieving and/or transforming data.

In one aspect, the advantages provided to the system by the module 112 includes expending fewer processor cycles generating and presenting the interactive pictorial user-interface compared to a system that does not implement module 112. A client device implementing module 112 will require less processing power because the module 112 is designed to efficiently retrieve and manipulate data necessary for the interactive pictorial user-interface. In turn, the module 112 allows for faster processing in a client device and an overall better user experience.

In another aspect, the advantages provided to the system by the module 112 include less traffic over the network 106. This is due, in part, to databases 118a and/or 118b which store data in a manner that is compatible with the module 112. As a result, the module 112 requires less bandwidth to retrieve insurance data for the interactive pictorial user-interface than a system that does not include the module 112. Thus, the system 100 can function more effectively due to reduced traffic over network 106, advantageously provided by the module 112.

In still another aspect, the module 112 provides the advantage of decreased memory consumption of the server 120 and client devices 136-146. Again, because the module 112 is designed to effectively retrieve data from databases 118a and/or 118b, the module requires less memory from the server 120 and/or client devices 136-146 compared to a system without module 112. Thus, the overall user experience is improved due to the efficiency and accuracy provided by the module 112.

### II. Exemplary Method

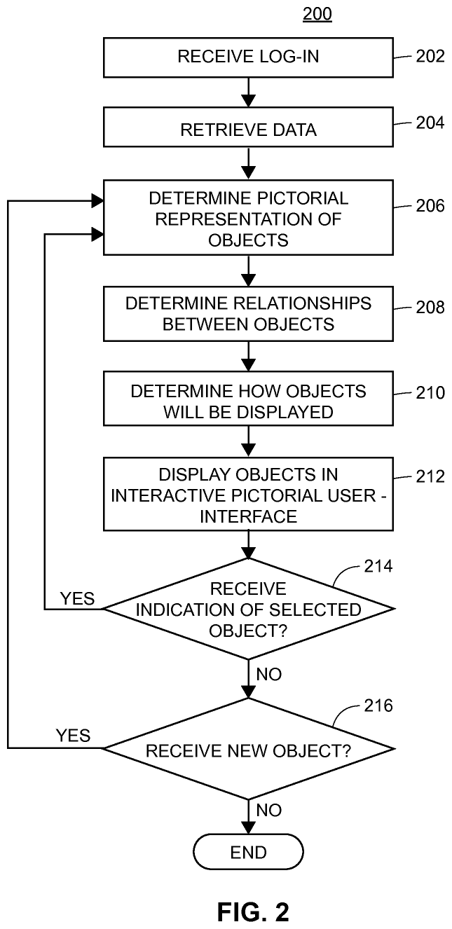

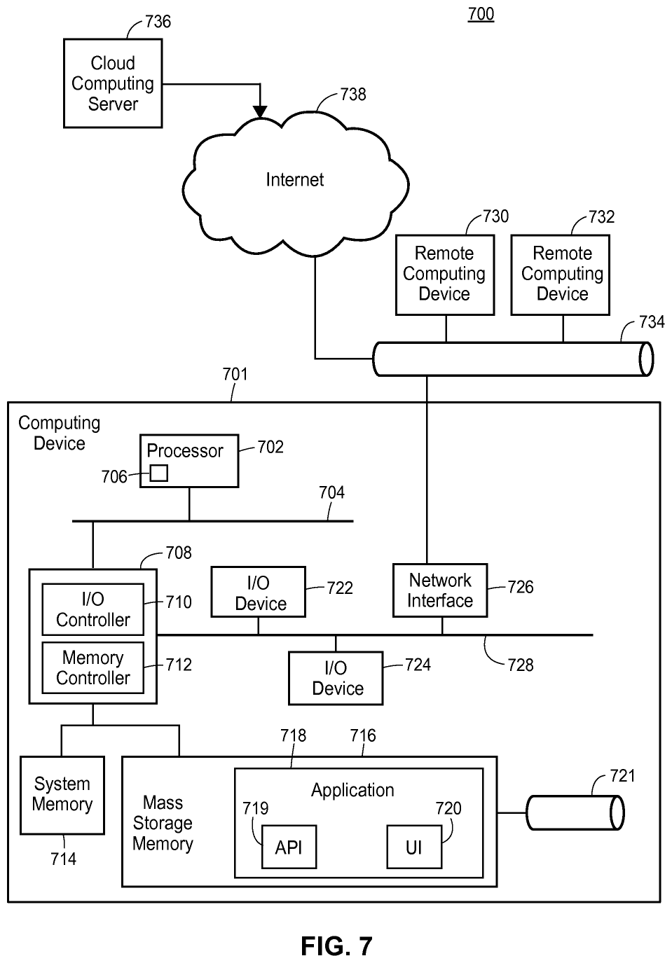

With reference to FIG. 2, the system 100 described herein may be employed in a method 200 to present insurance data within an interactive pictorial user-interface. The method 200 may include one or more functions and/or routines in the form of non-transitory computer-executable instructions that are stored in a tangible computer-readable storage medium and/or executed using a processor of a computing device (e.g., the client devices 136-146, the server 120, or any combination of computing devices within the system 100). The routines may be included as part of any of the modules described in relation to FIG. 1 above, and/or FIG. 7 below, and/or as part of a module that is external to the system illustrated by FIGS. 1 and/or 7. For example, the method 200 may be part of a browser application and/or another application running on the client devices 136-146 as a plugin and/or other module of the browser application.

The method 200 may begin after the system 100 receives a customer login (Block 202). By logging in, the user may access a profile in the customer database 118a. The data presented by the interactive display module 112 will be associated with the received login. In one embodiment, the system may receive a unique login ID and password to access a customer profile. In another embodiment, the user may implement a fingerprint scanner, an ID scanner and/or a magnetic swipe card to login to the system. In yet another embodiment, the user may implement a user interface of a client device to input user data to create a profile if the customer does not exist in the database 118a.

Once a login is received and a profile is identified, any data received may be associated with the identified profile. In one embodiment, all profiles in the customer database 118a may be associated with customers (policyholders) of the insurance provider. In another embodiment, profiles in the database 118a may be associated to or with registered users which do not have to be customers of an insurance provider. A profile in the database 118a may include any information related to a customer's insurance coverage, such as policies vehicles, homes, claims, people, etc.

After identifying a profile, the system may then retrieve insurance data to be presented in an interactive pictorial user-interface (Block 204). The system may implement the interactive display module 112 to retrieve data from databases 118a and/or 118b. In one embodiment, the module 112 may also retrieve data stored on client devices 136-146, such as personal demographic information. The module 112 may retrieve any data needed for the interactive pictorial UI.

Once the data is retrieved, the system 100 may then determine the pictorial representation of the objects (Block 206). Each piece of data retrieved by module 112 will be made into an object to be displayed in the interactive UI. The objects may be graphical or virtual representations of data that are intended to be easily recognizable. For example, an object corresponding to an individual covered under an auto insurance policy may be represented by a generic illustration, such as a stick figure or a virtual avatar.

In one embodiment, the module 112 may retrieve a profile picture associated with an individual as a pictorial representation for the object corresponding to the individual. Additionally or alternatively, the profile picture may be retrieved from a social media site corresponding to the individual. In another embodiment, the profile picture may be retrieved from a data storage on a client device and/or from the databases 118a and/or 118b.

Similarly, objects corresponding to vehicles and/or policies may be represented by pictorial representations comprising generic illustrations. In one embodiment, a photo of a vehicle may be retrieved by module 112 (from the internet, memory of client devices, and/or databases 118a and/or 118b) to be used as a pictorial representation of the object corresponding to the vehicle. Further, a screenshot, cover page and/or Portable Document Format (PDF) may be retrieved by the module 112 (from the internet, memory of client devices, and/or databases 118a and/or 118b) to be used as the pictorial representation for the object related to an insurance policy.

The above examples are not intended to encompass every possible pictorial representation of every object to be displayed in the interactive UI. The module 112 can represent any data associated with an insurance policy by any pictorial representation deemed appropriate by providers of the system 100. For example, virtual or graphical representations (such as icons) may represent insureds; family members of the insured; insured vehicles; homes, condos, or apartments insured; people insured; and/or other items insured. The virtual or graphical representations may be associated with various types of insurance policies, such as auto, home, life, health, renters, pet, burial, and/or other types of insurance. Additionally or alternatively, the virtual or graphical representations may be associated with individual insurance policies, premiums, rates, discounts, rewards, and/or points.

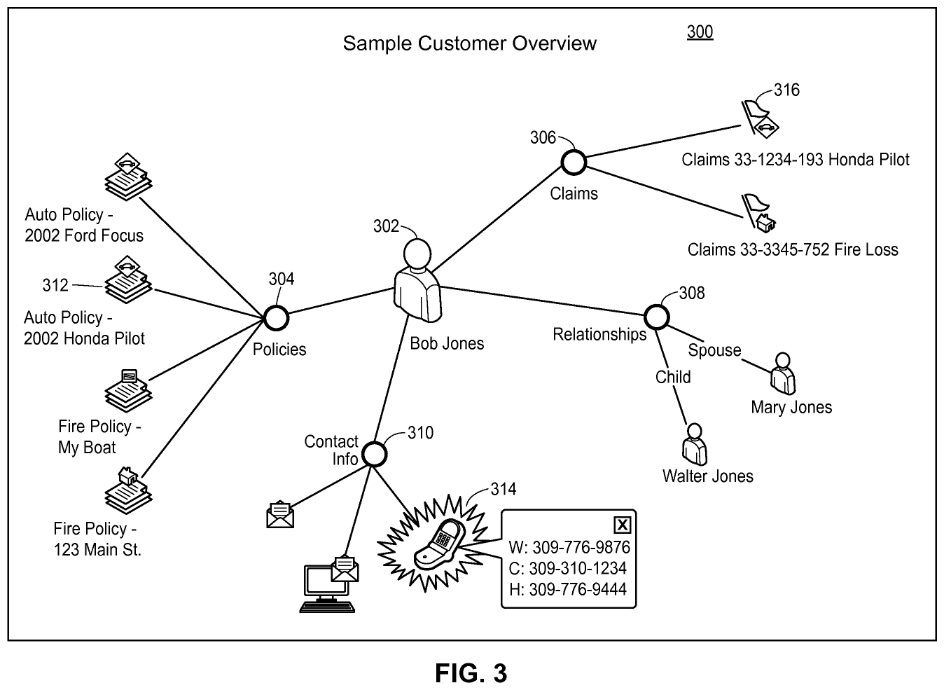

The system may then determine the relationships between the objects (Block 208). The module 112 may be implemented to determine relationships between objects. The determined relationships may be manifested in the display of the interactive UI, where the module 112 may represent the objects in a web-diagram. The determined relationships will be discussed in greater detail below with respect to FIGS. 3-6.

The system 100 may then determine how the objects will be displayed (Block 210). The system 100 may implement the module 112 to determine the size and/or shape of the display screen of the client device. The module may then determine the size and/or arrangement of the pictorial representation of the objects to be displayed in the web-diagram. The module 112 may also determine the appropriate configuration of objects to be displayed. For example, the module 112 may determine that the client device and/or log-in are associated with a customer “Bob Jones” and thus configure the web-diagram around the pictorial representation of the object (or icon, photo, or avatar) corresponding to customer “Bob Jones.”

### III. Exemplary Customer-Centric View

The system 100 may then display the objects in, or within, an interactive pictorial user-interface. FIG. 3 is an illustration of an exemplary interactive pictorial user-interface 300 displaying a customer view. In the exemplary interface 300, the module 112 has configured the web-diagram to feature the object 302 corresponding to customer “Bob Jones” as the central focal point. In the example, the module 112 has configured the branches of the web-diagram or virtual map to correspond to different insurance data related to the central object. The objects and/or branches illustrated in the exemplary interface 300 represent the previously determined (at Block 208) relationships between objects. In the exemplary interface 300, branches may extend from the central object 302 to insurance policies 304, claims 306, relationships 308 and/or contact information 310.

In the exemplary interface 300, policies 304 may include any insurance policy purchased by, or associated with, “Bob Jones” 302. In other embodiments, policies 304 may include any past and/or present insurance policy purchased by or for the individual. In one embodiment, policies 304 may include only policies provided by one insurance provider. In another embodiment, policies 304 may include any policy purchased by a customer, regardless of the insurance provider. The exemplary interface 300 may include policies 304 that include auto insurance coverage for two vehicles (such as auto insurance policy for a 2014 Honda Pilot 312) and fire (or home owners) insurance for a boat and for a home.

The exemplary interface 300 may include insurance claims 306 that correspond to “Bob Jones” 302. Claims 306 may include any insurance claim corresponding to a customer. In one embodiment, claims 306 may only correspond to claims made with one insurance provider. In another embodiment, claims 306 may include any claim corresponding to a customer, regardless of the corresponding insurance provider of the claim.

The exemplary interface 300 may also include relationships 308 that correspond to “Bob Jones” 302. The relationships 308 may include individuals, such as family members, covered by insurance policies corresponding to “Bob Jones” 302. In one embodiment, the individuals represented by objects 308 do not necessarily need to be covered by insurance policies.

The exemplary interface 300 may include information written on the branches extending from the node relationships 308 indicating the type of relationship of each object. Although none of the other branches of interface 300 include written information, this is not intended to be limiting, and any branch may include text relating to the connection between objects.

The exemplary interface 300 of FIG. 3 may include contact info 310. Contact info 310 may include any personal and/or demographic information corresponding to a customer. Contact info may include emails, phone numbers, addresses, social media addresses, and/or any other data relating to a customer.

Once the interactive pictorial user-interface is displayed, the system 100 may receive an indication of a selected object. The system may receive the indication via an I/O of an client device, such as a mouse click and/or a tap on a touch screen device. In one embodiment, any object of an interactive interface may be selected. In the exemplary interface 300 of FIG. 3, object 314 has been selected. The module 112 has altered the display of the user interface to highlight the object 314 and/or display additional information relating to the object 314. A selected object may be highlighted in a variety of manners, including altering the color, shading, shape, etc. of the pictorial representation of the object.

In the exemplary interface 300, the object 314 has only been selected once. If the object 314 were to be selected a second time, the module 112 may modify the web-diagram to be centered around the object 314.

### IV. Exemplary Insurance Policy-Centric View

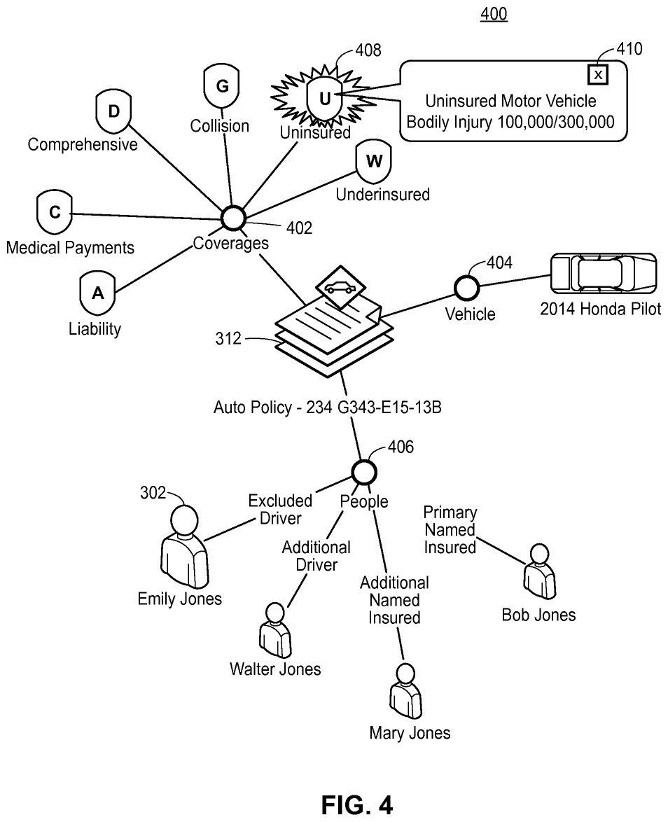

FIG. 4 is an illustration of exemplary interface 400 where the object 312 of FIG. 3 has been selected twice. In one embodiment, selecting an object once causes the object to be highlighted by altering the pictorial representation of the selected object, while selecting an object a second time causes the module 112 to reconfigure the web-diagram around the selected object. In the exemplary interface 400, the module 112 has reconfigured the web-diagram of interface 300 to include object 312 in the center of the web-diagram. The module 112 has further reconfigured the web-diagram in interface 400 by including new branches based upon the previously determined relationships between objects (Block 208) corresponding to object 312.

The exemplary user interface 400 illustrates a policy view, wherein the web-diagram may be centered around an insurance policy 312. In the exemplary interface 400, policy 312 represents an auto insurance policy, thus the interface 400 includes information pertinent to an auto insurance policy such as coverage 402, vehicle 404, and/or drivers or people 406. The exemplary interface 400 is not intended to be limiting, and further information relating to an auto insurance policy may be displayed in other embodiments.

The coverages displayed may relate to various coverages, deductibles, and/or limits associated with various types of insurance policies. For instance, the coverages 402 displayed for an auto insurance policy may include virtual representations of liability, medical payments, comprehensive, collision, uninsured driver, and/or underinsured driver coverages. Other coverages may be represented for other types of insurance, such as home or life insurance.

Also, virtual depictions of the item or person covered by the insurance policy may be presented. For instance, an icon representing a vehicle, home, or person may be displayed in relation to a virtual representation of the insurance policy. The people 406 displayed or virtually represented may be insureds or family members of an insured. For instance, the people 406 virtually represented may include a primary named insured; an additional named insured; an additional driver; and/or an excluded driver.

In the exemplary interface 400, object 408 has been selected. Thus, object 408 is highlighted and/or additional information for object 408 is displayed. In one embodiment, object 408 may be unselected by a click on the icon 410. If object 408 is unselected, the module 112 may determine that it no longer needs to be highlighted, and the module 112 will alter the display accordingly.

### V. Exemplary Insurance Claim-Centric View

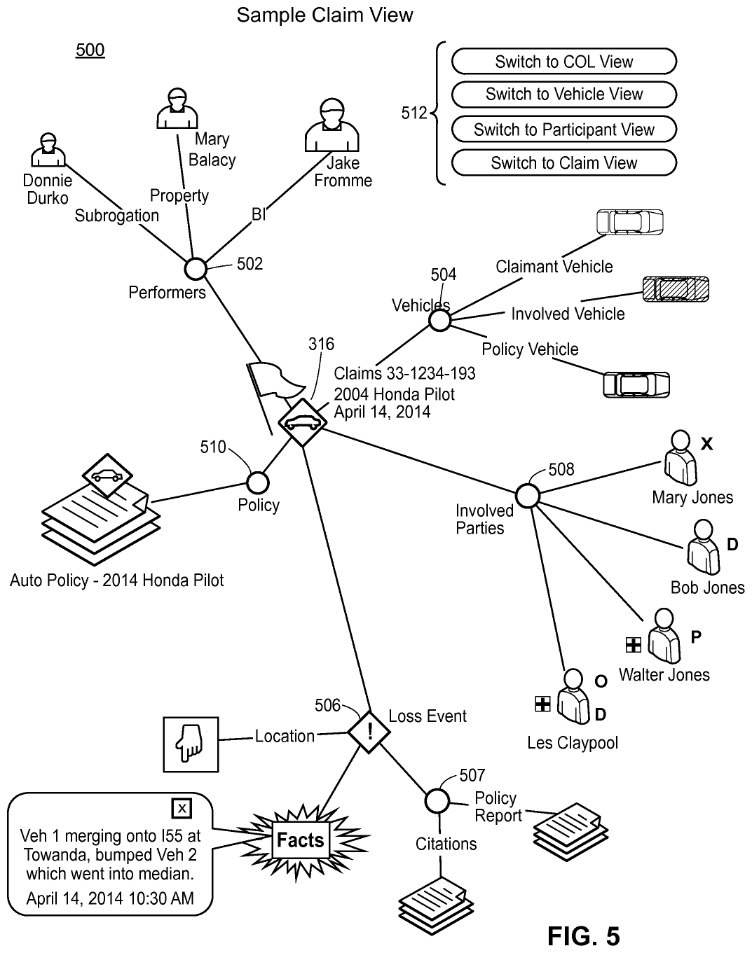

Referring now to FIG. 5, the illustration is of an exemplary interface 500 of an insurance claim view. In one embodiment, the module 112 may create the interface 500 in response to receiving an indication of two selections of claim 316 from FIG. 3. Upon receiving the selection of the object (claim 316), the module 112 may act accordingly by reconfiguring the interactive pictorial UI to be centered around the selected object, in this case an insurance claim. The exemplary interface 500 of a claim view may include information pertinent to an insurance claim, such as performers 502, vehicles 504, loss events 506, police reports 507, involved parties 508, and/or insurance policy 510. The exemplary interface 500 is not intended to be limiting, and further information relating to an insurance claim may be displayed in other embodiments.

A virtual representation of an insurance claim 316 may be centrally displayed. An insurance policy 510, a vehicle 504, an involved party 508, a performer 502, and/or loss event 506 associated with the insurance claim 316 may all have virtual representations that displayed in relation to the insurance claim 316 within the user-interface.

A number of vehicles 504 may be virtually depicted, such as a claimant vehicle, an involved vehicle, and/or a policy vehicle. Each vehicle may have a separate icon or virtual representation. Similarly, a number of involved parties 508 may be virtually depicted, such as a first driver; a first passenger; a second driver; and/or another person not involved but covered by a policy. A separate icon may indicate whether or not each party 508 was injured in a vehicle accident.

The loss event 506 virtually depicted may have several related icons, such as icons related to location, time, facts of the accident, citations, and/or police reports. The performers 502 may also have related icons, such as icons related to subrogation of insurance claims, property or property ownership, and/or bodily injury.

The exemplary interface 500 may further include a menu 512. The menu 512 may offer a user the ability to reconfigure the web-diagram of the interface around a different object focal point. For example, the menu 512 may allow a user to jump to a claim or claim-centric view, such as the claim view provided in the exemplary interface 400.

If the system 100 has not received an indication of a selected object, the system may receive a new object (Block 216). The module 112 may store the received object in one of the databases 118a, 118b and/or in a local memory of a client device. The module 112 may also determine a pictorial representation of the newly received object and/or determine relationships between the newly received object and existing objects. The module 112 may then determine how to display the data, including the newly received object and/or the previous objects. The module 112 may then display the objects in a new interactive pictorial user-interface.

### VI. Exemplary Loss Report-Centric View

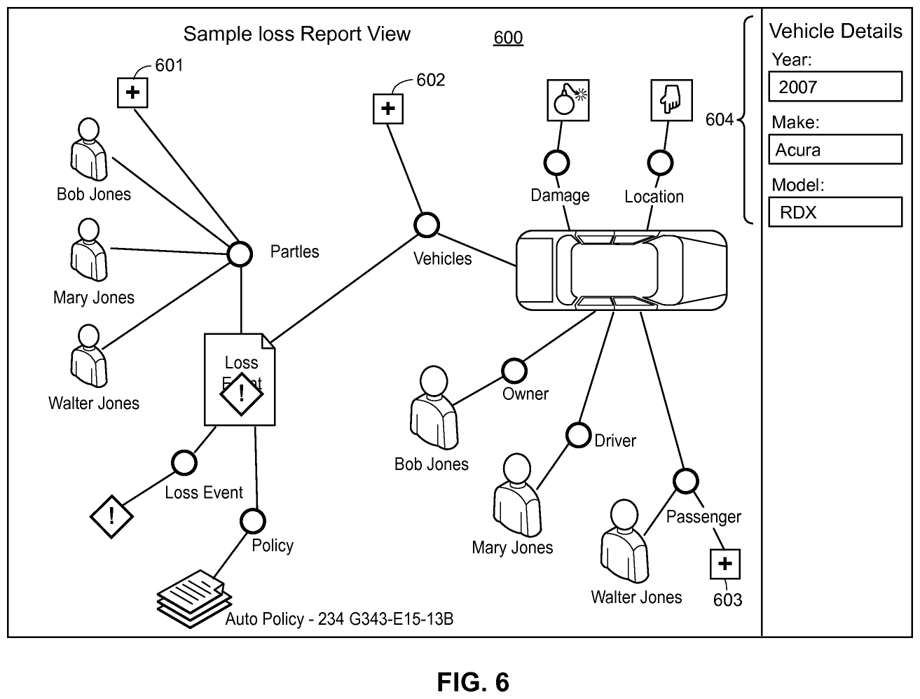

Referring to FIG. 6, an exemplary interface 600 displaying a loss report (and/or associated with a “data collection” mode) may be implemented to receive a new object. The interface 600 may include icons 601, 602 and 603 that may be implemented by a user to add an object. Although the icons 601-603 are only included in the exemplary interface 600, similar icons (such as “+” icons) for adding objects may be added to previous interfaces 300, 400, and/or 500.

In the exemplary interface 600, icon 602 has been selected. In response to the selection of icon 602, the module 112 may present an interactive menu 604 for adding an object. The menu 604 of the exemplary interface 600 may include input windows for receiving information corresponding to a vehicle to be added as an object to the interface 600. In other exemplary embodiments, the module 112 may allow the system to receive photos, video, documents, icons, avatars, etc. for data related to objects to be added to the interactive pictorial user-interface.

In some embodiments, the “+” and/or other icons, such as icons 601-603, may be used to facilitate data collection, such as during conversations between an insurance representative and an insurance customer. For instance, icons may be used to add parties; loss reports; loss events, insurance policies; vehicles; homes; insured items or people; family members; insurance customers; vehicle owners, drivers, or passengers; type or amount of damage; locations; and/or other items. The user-interface may be customer facing and/or insurance representative facing to facilitate communication between insurance provider and customer. Additionally or alternatively, clicking upon various objects (or icons) may highlight those objects (and/or icons) on the display screen or page.

### VII. Exemplary Computing Environment

FIG. 7 illustrates an exemplary computing environment for implementing the system 100 and/or method 200, as described herein. As shown in FIG. 7, the computing device 701 may include a processor 702 that is coupled to an interconnection bus 704. The processor 702 may include a register set or register space 706, which is depicted in FIG. 7 as being entirely on-chip, but which may alternatively be located entirely or partially off-chip and/or directly coupled to the processor 702 via dedicated electrical connections and/or via the interconnection bus 704. The processor 702 may be any suitable processor, processing unit or microprocessor. Although not shown in FIG. 7, the computing device 701 may be a multi-processor device and, thus, may include one or more additional processors that are identical or similar to the processor 702 and/or that are communicatively coupled to the interconnection bus 704.

The processor 702 of FIG. 7 may be coupled to a chipset 708, which may include a memory controller 712 and a peripheral input/output (I/O) controller 710. As is well known, a chipset typically provides I/O and memory management functions as well as a plurality of general purpose and/or special purpose registers, timers, etc. that are accessible or used by one or more processors coupled to the chipset 708. The memory controller 712 may perform functions that enable the processor 702 (or processors if there are multiple processors) to access a system memory 714 and a mass storage memory 716.

The system memory 714 may include any desired type of volatile and/or non-volatile memory such as, for example, static random access memory (SRAM), dynamic random access memory (DRAM), flash memory, read-only memory (ROM), etc. The mass storage memory 716 may include any desired type of mass storage device. For example, if the computing device 701 is used to implement a interactive user-interface module 718 having an API 719 (including functions and instructions as described by the method 200 of FIG. 2), and user interface 720 to receive user input, the mass storage memory 716 may include a hard disk drive, an optical drive, a tape storage device, a solid-state memory (a flash memory, a RAM memory, etc.), a magnetic memory (e.g., a hard drive), or any other memory suitable for mass storage. In one embodiment, non-transitory program functions, modules and routines (an application 718, an API 719, and the user interface 720, etc.) are stored in mass storage memory 716, loaded into system memory 714, and executed by a processor 702 or may be provided from computer program products that are stored in tangible computer-readable storage mediums (RAM, hard disk, optical/magnetic media, etc.). Mass storage 716 may also include a cache memory 721 storing application data, user profile data, and timestamp data corresponding to the application data, and other data for use by the application 718.

The peripheral I/O controller 710 may perform functions that enable the processor 702 to communicate with peripheral input/output (I/O) devices 722 and 724, a network interface 726, via a peripheral I/O bus 728. The I/O devices 722 and 724 may be any desired type of I/O device such as a keyboard, a display (a liquid crystal display (LCD), a cathode ray tube (CRT) display, etc.), a navigation device (a mouse, a trackball, a capacitive touch pad, a joystick, etc.), etc. The I/O devices 722 and 724 may be used with the application 718 to implement the interactive user-interface as described in relation to the figures. The local network transceiver 728 may include support for Wi-Fi network, Bluetooth, Infrared, cellular, or other wireless data transmission protocols. In other embodiments, one element may simultaneously support each of the various wireless protocols employed by the computing device 701. For example, a software-defined radio may be able to support multiple protocols via downloadable instructions.

In operation, the computing device 701 may be able to periodically poll for visible wireless network transmitters (both cellular and local network) on a periodic basis. Such polling may be possible even while normal wireless traffic is being supported on the computing device 701. The network interface 726 may be an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 712 and the I/O controller 710 are depicted in FIG. 7 as separate functional blocks within the chipset 708, the functions performed by these blocks may be integrated within a single integrated circuit or may be implemented using two or more separate integrated circuits. The system 700 may also implement the user interfaces 300, 400, 500 and 600 and interactive interface module 112 on remote computing devices 730 and 732. The remote computing devices 730 and 732 may communicate with the computing device 701 over a network link 734. For example, the computing device 701 may receive an interactive pictorial user-interface created by an application executing on a remote computing device 730, 732. In some embodiments, the application 718 including the user interfaces 300, 400, 500, 600 and module 112 may be retrieved by the computing device 701 from a cloud computing server 736 via the Internet 738. When using the cloud computing server 736, the retrieved application 718 may be programmatically linked with the computing device 701. The application 718 may be a Java® applet executing within a Java® Virtual Machine (JVM) environment resident in the computing device 701 or the remote computing devices 730, 732. The application 718 may also be “plug-ins” adapted to execute in a web-browser located on the computing devices 701, 730, and 732. In some embodiments, the application 718 may communicate with back-end components 740 such as the data system 104 via the Internet 738 or other type of network.

Using the system 100 and method 200 described herein, an interactive pictorial user-interface 112 may implement displays of client devices to present a visual representation of insurance data to better service, retain, and expand a customer base of an insurance provider. The insurance provider may expand on customer satisfaction by providing visually pleasing and easily understandable methods to present insurance data. By implementing methods to increase customer satisfaction, the insurance provider may benefit from a happier and sustained customer base.

### VIII. Exemplary Method of Displaying Insurance-Related Data

In one aspect, a computer-implemented method for displaying insurance data in an interactive pictorial user-interface may be provided. The method may include (1) receiving, via a computer network, a log-in corresponding to a customer of an insurance provider; and/or (2) retrieving, by one or more processors, one or more objects comprising insurance data corresponding to the customer of the insurance provider. The method may include (3) determining, by one or more processors, a pictorial or graphical representation for each of the one or more objects; (4) determining, by one or more processors, relationships between the one or more objects; and/or (5) determining, by one or more processors, a size and an arrangement of the pictorial representation of the one or more objects to be displayed based upon the determined relationships. The method may also include (6) displaying, via a display of a client device, the objects in an interactive user-interface based upon the determined size and/or arrangement of the pictorial representation of the one or more objects. The pictorial representation of the one or more objects may include a plurality of nodes in a web-diagram and/or a plurality of branches of the web-diagram may correspond to the determined relationships of the objects.

The method may also include receiving, via an input of a client device, an indication of a selection of a particular object; and/or altering the display of the interactive user-interface by highlighting the selected particular object. Highlighting the selected particular object may include altering the pictorial representation of the selected particular object.

The method may include receiving, via an input of a client device, an indication of a second selection of the particular object; and/or determining a new arrangement of the one or more objects oriented around the twice selected particular object. The method may also include displaying the objects based upon the determined new arrangement.

The one or more objects may include insurance policies (such as auto, home, renters, life, health insurance), insurance claims, customer contact info, relationships between insured individuals, insured vehicles, insured property, types of insurance coverage, individuals covered by an insurance policy, individuals involved in an insurance claims, vehicles involved in an insurance claim, insurance policies involved in an insurance claim, loss events of an insurance claim, and/or police reports related to an insurance claim.

The method may include receiving, via an input of a client device, a new object corresponding to insurance data to be displayed in the interactive pictorial user-interface. The method may be installed as part of an application on a mobile device. The method may include additional, fewer, or alternate actions, including those discussed elsewhere herein.

### IX. Exemplary Device for Displaying Insurance-Related Data

In another aspect, a computer device implemented or configured to display insurance data in an interactive pictorial user-interface may be provided. The computer device may comprise one or more processors and one or more memories coupled to the one or more processors. The one or more memories may include computer executable instructions stored therein that, when executed by the one or more processors, cause the one or more processors to perform a plurality of functions. For example, the instructions may cause the one or more processors to receive a log-in corresponding to a customer of an insurance provider; and/or retrieve one or more objects comprising insurance data corresponding to the customer of the insurance provider. The instructions may further cause the one or more processors to determine a pictorial representation for each of the one or more objects; determine relationships between the one or more objects; and/or determine a size and an arrangement of the pictorial representation of the one or more objects to be displayed based upon the determined relationships. The instructions may further cause the one or more processors to display the objects in an interactive user-interface based upon the determined size and/or arrangement of the pictorial representation of the one or more objects. The pictorial representation of the one or more objects may include a plurality of nodes in a web-diagram, and/or a plurality of branches of the web-diagram may correspond to the determined relationships of the objects.

The instructions of the computer device may further cause the one or more processors to receive an indication of a selection of a particular object; and/or alter the display of the interactive user-interface by highlighting the selected particular object. Highlighting the selected particular object may include altering the pictorial representation of the selected particular object.

The instructions of the computer device may further cause the one or more processors to receive an indication of a second selection of the particular object; determine a new arrangement of the one or more objects oriented around the twice selected particular object; and/or cause the one or more processors to display the objects based upon the determined new arrangement.

The foregoing embodiment may include the computer-system above, wherein the one or more objects may include insurance policies, insurance claims, customer contact info, relationships between insured individuals, insured vehicles, insured property, types of insurance coverage, individuals covered by an insurance policy, individuals involved in an insurance claims, vehicles involved in an insurance claim, insurance policies involved in an insurance claim, loss events of an insurance claim, and/or police reports related to an insurance claim.

The instructions of the computer device may further cause the one or more processors to receive a new object corresponding to insurance data to be displayed in the interactive pictorial user-interface. The computer device may include additional, less, or alternate functionality, including that discussed elsewhere herein.

### X. Exemplary Computer Instructions & Functionality

In another aspect, a tangible computer-readable medium may include non-transitory computer readable instructions stored thereon to display insurance data in an interactive pictorial user-interface. For example, the instructions may include receiving, a log-in corresponding to a customer of an insurance provider; and/or retrieving one or more objects comprising insurance data corresponding to the customer of the insurance provider. The instructions may also include determining a pictorial representation for each of the one or more objects; determining relationships between the one or more objects; and/or determining a size and/or an arrangement of the pictorial representation of the one or more objects to be displayed based upon the determined relationships. The instructions may also include displaying the objects in an interactive user-interface based upon the determined size and/or arrangement of the pictorial representation of the one or more objects. The pictorial representation of the one or more objects may include a plurality of nodes in a web-diagram and/or a plurality of branches of the web-diagram may correspond to the determined relationships of the objects.

The instructions may include causing the one or more processors to receive an indication of a selection of a particular object. The instructions may further include altering the display of the interactive user-interface by highlighting the selected particular object. Highlighting the selected particular object may include altering the pictorial representation of the selected particular object.

The instructions may include receiving an indication of a second selection of the particular object. The instructions may further include determining a new arrangement of the one or more objects oriented around the twice selected particular object; and/or displaying the objects based upon the determined new arrangement.

The one or more objects may include insurance policies, insurance claims, customer contact info, relationships between insured individuals, insured vehicles, insured property, types of insurance coverage, individuals covered by an insurance policy, individuals involved in an insurance claims, vehicles involved in an insurance claim, insurance policies involved in an insurance claim, loss events of an insurance claim, and/or police reports related to an insurance claim.

The instructions may further include receiving a new object corresponding to insurance data to be displayed in the interactive pictorial user-interface. The pictorial representation of the object may be a photo (or virtual likeness) of a person, or an item that the object represents. The computer-readable instructions may include additional, less, or alternate functionality, including that discussed elsewhere herein.

### XI. Exemplary Method of Displaying Insurance-Related Data

In one aspect, a computer-implemented method for displaying insurance data in an interactive pictorial user-interface may be provided. The method may include (1) receiving, via one or more processors, a request for insurance-related information associated with a customer from a customer computing device, such as via wireless communication or data transmission; (2) generating, via the one or more processors, an insurance customer-centric view (or page, webpage, or display screen), the insurance customer-centric view includes a graphical or virtual representation of insurance-related information and a graphical or virtual representation (e.g., icon or avatar) or a digital representation (e.g., digital photo) of the insured, wherein the graphical, virtual, or digital representation of the insured is centrally located (or approximately centrally located) within the insurance customer-centric view, and/or the insurance customer-centric view including a graphical or virtual depiction of pieces or objects of insurance-related information that are related to the insured; (3) generating, via the one or more processors, an insurance policy-centric view (or page, webpage, or display screen), the insurance policy-centric view includes a graphical or virtual representation of insurance-related information and a graphical or virtual representation (e.g., icon or avatar) or a digital representation (e.g., digital photo) of an insurance policy, wherein the graphical, virtual, or digital representation of the insurance policy is centrally located (or approximately centrally located) within the insurance policy-centric view, and/or the insurance policy-centric view including a graphical or virtual depiction of pieces or objects of insurance-related information that are related to the insurance policy; (4) generating, via the one or more processors, an insurance claim-centric view (or page, webpage, or display screen), the insurance claim-centric view includes a graphical or virtual representation of insurance-related information and a graphical or virtual representation (e.g., icon or avatar) or a digital representation (e.g., digital photo) of an insurance claim, wherein the graphical, virtual, or digital representation of the insurance claim is centrally located (or approximately centrally located) within the insurance claim-centric view, and/or the insurance claim-centric view including a graphical or virtual depiction of pieces or objects of insurance-related information that are related to the insurance claim; (5) generating, via the one or more processors, a loss report-centric view (or page, webpage, or display screen), the loss report-centric view includes a graphical or virtual representation of insurance-related information and a graphical or virtual representation (e.g., icon or avatar) or a digital representation (e.g., digital photo) of a loss report, wherein the graphical, virtual, or digital representation of the loss report is centrally located (or approximately centrally located) within the loss report-centric view, and/or the loss report-centric view including a graphical or virtual depiction of pieces or objects of insurance-related information that are related to the loss report; and/or (6) causing or presenting, via the one or more processors, the insurance customer-centric view, the insurance policy-centric view, the insurance claim-centric view, and/or the loss report-centric view (all associated with the insurance customer) to be presented or displayed on a display screen of a computing device of the insurance customer (such as by transmitting associated webpages or virtual display screens from the one or more processors to the insurance customer computing device via wireless communication or data transmission) to facilitate insurance customer review, analysis, approval, and/or modification of insurance-related information, insurance policies, insurance claims, and/or loss reports. The method may include additional, fewer, or alternate actions, including those discussed elsewhere herein.

The insurance-related information displayed may relate to a type of insurance, insurance claim, or insurance policy that includes auto, home, fire, renters, life, health, pet, burial or other types of insurance. The type of insurance-related information that is virtually or graphically represented on a display, page, or webpage (such as the insurance customer-centric view, the insurance policy-centric view, the insurance claim-centric view, and/or the loss report-centric view) may include and/or be associated with insurance policies, premiums, rates, and/or discounts, and/or insurance customers, family members, pets, police reports, insurance claims, vehicles, and/or homes.

Virtual objects that are virtually or graphically represented on a display, page, or webpage (such as the insurance customer-centric view, the insurance policy-centric view, the insurance claim-centric view, and/or the loss report-centric view) include and/or are associated with insurance policies, premiums, rates, and/or discounts, and/or insurance customers, family members, pets, police reports, insurance claims, vehicles, and/or homes.

### XII. Exemplary Customer-Centric User-Interface View

In one aspect, a graphical user-interface for displaying insurance-related information may be provided. The user-interface may include an insurance customer-centric view (or page, webpage, or display screen), the insurance customer-centric view includes a graphical or virtual representation of insurance-related information and a graphical or virtual representation (e.g., icon or avatar) or a digital representation (e.g., digital photo) of the insured. The graphical, virtual, or digital representation of the insured may be centrally located (or approximately centrally located) within the insurance customer-centric view, and/or the insurance customer-centric view may include (i) a graphical or virtual depiction of pieces or objects of insurance-related information that are related to the insured, and/or (ii) a graphical or virtual depiction of the relationship between the insured and each of the pieces or objects of insurance-related information.

The graphical user-interface may include additional, less, or alternate functionality, including that discussed elsewhere herein. For instance, the user-interface may further include a graphical or virtual representation of one or more insurance policies; customer contact information; one or more insurance claims; and/or one or more people associated with the insurance customer.

### XIII. Exemplary Insurance Customer-Centric User-Interface View

In one aspect, a graphical user-interface for displaying insurance-related information may be provided. The user-interface may include an insurance policy-centric view (or page, webpage, or display screen), the insurance policy-centric view includes a graphical or virtual representation of insurance-related information and a graphical or virtual representation (e.g., icon or avatar) or a digital representation (e.g., digital photo) of an insurance policy. The graphical, virtual, or digital representation of the insurance policy may be centrally located (or approximately centrally located) within the insurance policy-centric view, and/or the insurance policy-centric view may include (i) a graphical or virtual depiction of pieces or objects of insurance-related information that are related to the insurance policy; and/or (ii) a graphical or virtual depiction of the relationship between the insurance policy and each of the pieces or objects of insurance-related information.

The graphical user-interface may include additional, less, or alternate functionality, including that discussed elsewhere herein. For instance, the graphical user-interface may further include a graphical or virtual representation of various coverages and/or one or more people. The various coverages may include and/or are associated with liability, medical payments, comprehensive, collision, uninsured driver, and/or underinsured drivers. The one or more people may include primary or additional insureds, and/or additional or excluded drivers.

### XIV. Exemplary Insurance Claim-Centric User-Interface View

In one aspect, a graphical user-interface for displaying insurance-related information may be provided. The user-interface may include an insurance claim-centric view (or page, webpage, or display screen), the insurance claim-centric view includes a graphical or virtual representation of insurance-related information and a graphical or virtual representation (e.g., icon or avatar) or a digital representation (e.g., digital photo) of an insurance claim. The graphical, virtual, or digital representation of the insurance claim may be centrally located (or approximately centrally located) within the insurance claim-centric view. The insurance claim-centric view may include (i) a graphical or virtual depiction of pieces or objects of insurance-related information that are related to the insurance claim, and/or (ii) a graphical or virtual depiction of the relationship between the insurance claim and each of the pieces or objects of insurance-related information.

The graphical user-interface may include additional, less, or alternate functionality, including that discussed elsewhere herein. For instance, the graphical user-interface may further include a graphical or virtual representation of one or more vehicles, such as a claimant vehicle, an involved vehicle, and/or a policy vehicle. The user-interface may further include a graphical or virtual representation of one or more insurance policies, and/or one or more performers. Additionally or alternatively, the user-interface may further include a graphical or virtual representation of a loss event, and/or one or more objects associated with the loss event, such as a location, facts associated with the loss event, citations, and/or police reports.

### XV. Exemplary Loss Report-Centric User-Interface View

In one aspect, a graphical user-interface for displaying insurance-related information may be provided. The user-interface may include a loss report-centric view (or page, webpage, or display screen), the loss report-centric view includes a graphical or virtual representation of insurance-related information and a graphical or virtual representation (e.g., icon or avatar) or a digital representation (e.g., digital photo) of a loss report. The graphical, virtual, or digital representation of the loss report may be centrally located (or approximately centrally located) within the loss report-centric view. The loss report-centric view may include (i) a graphical or virtual depiction of pieces or objects of insurance-related information that are related to the loss report; and/or (ii) a graphical or virtual depiction of the relationship between the loss report and each of the pieces or objects of insurance-related information.

The graphical user-interface may include additional, less, or alternate functionality, including that discussed elsewhere herein. For instance, the user-interface may further include a graphical or virtual representation of a lost event, an insurance policy, one or more parties, and/or one or more vehicles.

For all of the different user-interface views mentioned herein, a type of insurance, insurance claim, or insurance policy may include or relate to auto, home, fire, renters, life, health, pet, burial or other types of insurance. A type of insurance-related information that is virtually or graphically represented on a display, page, or webpage (such as the insurance customer-centric view, the insurance policy-centric view, the insurance claim-centric view, and/or the loss report-centric view) may include and/or be associated with insurance policies, premiums, rates, and/or discounts, and/or insurance customers, family members, pets, police reports, insurance claims, vehicles, and/or homes. Virtual objects that are virtually or graphically represented on a display, page, or webpage (such as the insurance customer-centric view, the insurance policy-centric view, the insurance claim-centric view, and/or the loss report-centric view) may include and/or may be associated with insurance policies, premiums, rates, and/or discounts, and/or insurance customers, family members, pets, police reports, insurance claims, vehicles, and/or homes.

### XVI. Additional Considerations

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

For example, the network 106, may include, but is not limited to, any combination of a LAN, a MAN, a WAN, a mobile, a wired or wireless network, a private network, or a virtual private network. Moreover, it is understood that any number of client computers or display devices are supported and may be in communication with the data system 104.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain functions. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, which may be one of an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of exemplary functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors). These operations are accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computer system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for presenting insurance data through an interactive pictorial user-interface through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for displaying data in an interactive web-diagram comprising:
receiving, via a computer network, a log-in corresponding to a user;
retrieving, by one or more processors, a plurality of objects comprising data corresponding to the user;
determining, by one or more processors, a pictorial representation for each of the plurality of objects based upon the data corresponding to the user;
retrieving, by one or more processors, the pictorial representation for each of the plurality of objects from one or more devices including at least a client device;
determining, by one or more processors, relationships between each of the plurality of objects;
receiving, by one or more processors, a display size of a display of the client device; and
creating, by one or more processors, an interactive web-diagram for display including a plurality of nodes featuring a new object node, wherein the plurality of nodes is interconnected by a plurality of branches, wherein each node of the plurality of nodes corresponds to an object of the plurality of objects, wherein the new object node allows the user to input a new object into the interactive web-diagram without transitioning away from the interactive web-diagram, the new object representing data to be displayed as a corresponding new node in the interactive web-diagram, and wherein creating the interactive web-diagram for display includes:
determining a size and an arrangement of each node of the plurality of nodes and each branch of the plurality of branches based upon: (i) the pictorial representation of the respective corresponding object of each node, (ii) the relationships between each of the plurality of objects, and (iii) the display size of the client device, where the nodes corresponding to objects that are determined to be closely related are arranged in closer proximity to each other, and wherein each node is depicted as the pictorial representation of the respective corresponding object,
displaying, via the display of the client device, the interactive web-diagram,
receiving, via the client device, a user input indicating a selection of a particular node from the plurality of nodes, and
in response to the user input, automatically altering the interactive web-diagram such that the particular node is highlighted and additional information corresponding to the particular node is displayed within the interactive web-diagram and located at least partially outside the particular node.

2. The computer-implemented method of claim 1, wherein altering the web-diagram further comprises:
altering a color and shape of the selected particular node.

3. (canceled)

4. The computer-implemented method of claim 2, further comprising:
receiving, via the input of the client device, an indication of a second selection of the particular node; and
reconfiguring the interactive web-diagram such that the interactive web-diagram is oriented around the twice selected particular node.

5. The computer-implemented method of claim 1, wherein the one or more objects can include insurance policies, insurance claims, customer contact info, relationships between insured individuals, insured vehicles, insured property, types of insurance coverage, individuals covered by an insurance policy, individuals involved in an insurance claims, vehicles involved in an insurance claim, insurance policies involved in an insurance claim, loss events of an insurance claim and police reports related to an insurance claim.

6. The computer-implemented method of claim 1, further comprising:
receiving, via an input of the client device, a new object corresponding to data to be displayed as a corresponding new node in the interactive web-diagram.

7. The computer-implemented method of claim 1, further comprising:
installing an application corresponding to the interactive web-diagram on the client device; and
initiating the interactive web-diagram in response to a selection of the application.

8. A system for displaying data in an interactive web-diagram, the system comprising:
a client device including an input and a display;
a data server including one or more processors and one or more memories, the memories including non-transitory instructions executed on the one or more processors to:
receive a log-in corresponding to a user;
retrieve a plurality of objects comprising data corresponding to the user;
determine a pictorial representation for each of the plurality of objects based upon the data corresponding to the user;
retrieve the pictorial representation for each of the plurality of objects from one or more objects including at least the client device;
determine relationships between each of the plurality of objects;
receive a display size of the display of the client device; and
create an interactive web-diagram for display including a plurality of nodes featuring a new object node, wherein the plurality of nodes is interconnected by a plurality of branches, wherein each node of the plurality of nodes corresponds to an object of the plurality of objects, wherein the new object node allows the user to input a new object into the interactive web-diagram without transitioning away from the interactive web-diagram, the new object representing data to be displayed as a corresponding new node in the interactive web-diagram, and wherein the instructions to create the interactive web-diagram for display further include:
determining a size and an arrangement of each node of the plurality of nodes and each branch of the plurality of branches based upon: (i) the pictorial representation of the respective corresponding object of each node, (ii) the relationships between each of the plurality of objects, and (iii) the display size of the client device, where the nodes corresponding to objects that are determined to be closely related are arranged in closer proximity to each other, and wherein each node is depicted as the pictorial representation of the respective corresponding object,
display, via the display of the client device, the interactive web-diagram,
receive a user input indicating a selection of a particular node from the plurality of nodes, and
in response to the user input, automatically altering the interactive web-diagram such that the particular node is highlighted and additional information corresponding to the particular node is displayed within the interactive web-diagram and located at least partially outside the particular node.

9. The computer-system of claim 8, including further instructions executed on the one or more processors to:
alter a color and shape of the selected particular node.

10. (canceled)

11. The computer-system of claim 9, including further instructions executed on the one or more processors to:
receive an indication of a second selection of the particular node;
reconfigure the web-diagram such that the web-diagram is oriented around the twice selected particular node.

12. The computer-system of claim 8, wherein the one or more objects can include insurance policies, insurance claims, customer contact info, relationships between insured individuals, insured vehicles, insured property, types of insurance coverage, individuals covered by an insurance policy, individuals involved in an insurance claims, vehicles involved in an insurance claim, insurance policies involved in an insurance claim, loss events of an insurance claim and police reports related to an insurance claim.

13. The computer-system of claim 8, including further instructions executed on the one or more processors to:
receive a new object corresponding to data to be displayed as a corresponding new node in the interactive web-diagram.

14. A tangible computer-readable medium including non-transitory computer readable instructions stored thereon for displaying data in an interactive web-diagram, the instructions to:
receive a log-in corresponding to a user;
retrieve a plurality of objects comprising data corresponding to the user;
determine a pictorial representation for each of the plurality of objects based upon the data corresponding to the user;
retrieve the pictorial representation for each of the plurality of objects from one or more devices including at least a client device;
determine relationships between each of the plurality of objects;
receive a display size of a display of the client device; and
create an interactive web-diagram for display including a plurality of nodes featuring a new object node, wherein the plurality of nodes is interconnected by a plurality of branches, wherein each node of the plurality of nodes corresponds to an object of the plurality of objects, wherein the new object node allows the user to input a new object into the interactive web-diagram without transitioning away from the interactive web-diagram, the new object representing data to be displayed as a corresponding new node in the interactive web-diagram, and wherein the instructions to create the interactive web-diagram for display further include:
determining a size and an arrangement of each node of the plurality of nodes and each branch of the plurality of branches based upon: (i) the pictorial representation of the respective corresponding object of each node, (ii) the relationships between each of the plurality of objects, and (iii) the display size of the client device, where the nodes corresponding to objects that are determined to be closely related are arranged in closer proximity to each other, and wherein each node is depicted as the pictorial representation of the respective corresponding object,
display, via the display of the client device, the interactive web-diagram,
receive a user input indicating a selection of a particular node from the plurality of nodes, and
in response to the user input, automatically altering the interactive web-diagram such that the particular node is highlighted and additional information corresponding to the particular node is displayed within the interactive web-diagram and located at least partially outside the particular node.

15. The tangible computer-readable medium of claim 14, including further instructions to:
receive an indication of a selection of a particular object; and
alter a color and shape of the display of the interactive web-diagram by highlighting the selected particular node object.

16. (canceled)

17. The tangible computer-readable medium of claim 15, including further instructions to:
receive an indication of a second selection of the particular node;
reconfigure the interactive web-diagram such that the interactive web-diagram is oriented around the twice selected particular node.

18. The tangible computer-readable medium of claim 14, wherein the one or more objects can include insurance policies, insurance claims, customer contact info, relationships between insured individuals, insured vehicles, insured property, types of insurance coverage, individuals covered by an insurance policy, individuals involved in an insurance claims, vehicles involved in an insurance claim, insurance policies involved in an insurance claim, loss events of an insurance claim and police reports related to an insurance claim.

19. The tangible computer-readable medium of claim 14, including further instructions to:
receive a new object corresponding to data to be displayed as a corresponding new node in the interactive web-diagram.

20. The tangible computer-readable medium of claim 14, wherein the pictorial representation of the object is a photo of a person or an item that the object represents.
